(19) United States
(12) Patent Application Publication
(10) Pub. No.: US 2022/0401773 A1
(43) Pub. Date: Dec. 22, 2022

(54) ROTATABLE COUPLING FOR FIRE SUPPRESSION SYSTEM

(71) Applicant: Tyco Fire Products LP, Lansdale, PA (US)

(72) Inventor: Adam M. Staszak, Marinette, WI (US)

(73) Assignee: Tyco Fire Products LP, Lansdale, PA (US)

(21) Appl. No.: 17/777,449

(22) PCT Filed: Dec. 18, 2020
(86) PCT No.: PCT/IB2020/062236

§ 371 Date: May 17, 2022

Related U.S. Application Data
(60) Provisional application No. 62/951,487, filed on Dec. 20, 2019.

(51) Int. Cl. A62C 31/28; A62C 35/68

(52) U.S. Cl. CPC A62C 31/28; A62C 35/68

(57) ABSTRACT

A rotating conduit assembly for a fire suppression system includes a first conduit configured to fluidly coupled with a fluid source, a second conduit, and a rotatable coupling. The rotatable coupling is configured to rotatably couple the first conduit with the second conduit. The rotatable coupling includes a first annular member fixedly coupled with the first conduit, a second annular member fixedly coupled with the second conduit, an inner sleeve, an annular seal, and a rotational actuator. The inner sleeve extends between the first annular member and the second annular member. The annular seal is disposed between the inner sleeve and the second annular member and is configured to provide a fluidic seal between the inner sleeve and the second annular member. The rotational actuator is disposed radially outward from the inner sleeve and configured to rotate the first annular member relative to the second annular member.

### CROSS-REFERENCE TO RELATED PATENT APPLICATION

This application claims the benefit of and priority to U.S. Provisional Patent Application No. 62/951,487, filed Dec. 20, 2019, the entire disclosure of which is incorporated by reference herein.

### BACKGROUND

The present disclosure relates generally to fire suppression systems. More specifically, the present disclosure relates to systems utilizing rotatable couplings for directing the discharge of fire suppressant fluid/agents.

Fire suppression systems are commonly used to protect an area and objects within the area from fire. Fire suppression systems can be activated manually or automatically in response to an indication that a fire is present nearby (e.g., an increase in ambient temperature beyond a predetermined threshold value, etc.). Once activated, fire suppression systems spread a fire suppressant fluid/agent throughout the area. The fire suppressant fluid/agent then suppresses and/or controls the fire. In some applications, the fire suppression systems include a rotatable section so that the fire suppressant fluid/agent may be redirected towards the fire or continually rotated to cover an area consistently.

### SUMMARY

At least one embodiment relates to a rotating conduit assembly for a fire suppression system. The conduit assembly includes a first conduit configured to fluidly coupled with a fluid source, a second conduit, and a rotatable coupling. The rotatable coupling is configured to rotatably couple the first conduit with the second conduit. The rotatable coupling includes a first annular member fixedly coupled with the first conduit, a second annular member fixedly coupled with the second conduit, an inner sleeve, an annular seal, and a rotational actuator. The inner sleeve extends between the first annular member and the second annular member. The annular seal is disposed between the inner sleeve and the second annular member and is configured to provide a fluidic seal between the inner sleeve and the second annular member. The rotational actuator is disposed radially outward from the inner sleeve and configured to rotate the first annular member relative to the second annular member.

In some embodiments, the rotating conduit assembly further includes an annular bearing disposed between the inner sleeve and the second annular member.

In some embodiments, the rotational actuator includes an input gear disposed within a gear box. In some embodiments, the gear box is fixedly coupled to the first annular member. In some embodiments, the rotational actuator includes an annular gear that engages the input gear and is fixedly coupled with the second annular member. In some embodiments, the rotational actuator includes a motor coupled with the input gear for rotating the second annular member with respect to the first annular member.

In some embodiments, at least one of the first conduit and second conduit form an elbow.

In some embodiments, the second annular member includes a step at a radially inwards position of the second annular member and an annular protrusion extending radially inwards from the second annular member. In some embodiments, the annular seal is positioned between the step and the annular protrusion.

In some embodiments, a step extends radially outward from the first annular member. In some embodiments, the bearing is coupled with the step. In some embodiments, an axial position of the bearing is limited in one axial direction by the step.

In some embodiments, the rotating conduit assembly further includes a third conduit fluidly coupled with the second conduit, a fourth conduit and a second rotatable coupling fluidly coupled with the third conduit and the fourth conduit.

In some embodiments, at least one of the first conduit, second conduit, third conduit, or the fourth conduit form an elbow. In some embodiments, the fourth conduit is fluidly coupled with a nozzle.

At least another embodiment of the present disclosure relates to a mobile fire suppression system. The mobile fire suppression system includes a mobile mount, a first conduit coupled with the mobile mount and configured to fluidly couple with a fluid source, a second conduit, and a rotatable coupling. The rotatable coupling provides a sealed fluid flow path between the first conduit and the second conduit for providing relative rotation between the first conduit and the second conduit. The rotatable coupling includes a first annular member, a second annular member, an inner sleeve, an annular seal, and a rotational actuator. The first annular member is fixedly coupled with the first conduit. The second annular member is fixedly coupled with the second conduit. The inner sleeve extends between the first annular member and the second annular member. The annular seal is disposed between the inner sleeve and the second annular member and configured to provide a fluidic seal between the inner sleeve and the second annular member. The rotational actuator is disposed radially outward from the inner sleeve and configured to rotate the first annular member relative to the second annular member.

In some embodiments, the mobile fire suppression system also includes an annular bearing disposed between the inner sleeve and the second annular member.

In some embodiments, the rotational actuator includes an input gear, an annular gear, and a motor. In some embodiments, the input gear is disposed within a gear box. In some embodiments, the gear box is fixedly coupled with the first annular member. In some embodiments, the annular gear engages the input gear and fixedly couples with the second annular member. In some embodiments, the motor is coupled with the input gear for rotating the second annular member with respect to the first annular member.

In some embodiments, the second annular member includes a step at a radially inwards position of the second annular member, and an annular protrusion extending radially inwards from the second annular member. In some embodiments, the annular seal is positioned between the step and the annular protrusion.

In some embodiments, a step extends radially outward from the first annular member. In some embodiments, the bearing is coupled with the step. In some embodiments, an axial position of the bearing is limited in one axial direction by the step.

In some embodiments, the mobile fire suppression system further includes a third conduit fluidly coupled with the second conduit, a fourth conduit, and a second rotatable coupling fluidly coupled with the third conduit and the fourth conduit.

In some embodiments, at least one of the first conduit, second conduit, third conduit, and fourth conduit form an elbow and wherein the fourth conduit is fluidly coupled with a nozzle.

Another embodiment of the present disclosure relates to a rotatable coupling. The rotatable coupling includes a first flange, a second flange, an inner sleeve, a seal, an alignment bearing, and a drive member. The first flange is configured to fluidly couple with a first conduit. The second flange is configured to fluidly couple with a second conduit. The inner sleeve is positioned between the first flange and the second flange. The inner sleeve fixedly couples to the first flange and rotatably couples to the second flange. The seal is disposed between the inner sleeve and the second flange. The alignment bearing is disposed between the inner sleeve and the second flange. The drive member is positioned radially outward from the inner sleeve and longitudinally between the first flange and the second flange and configured to rotate the second flange relative to the first flange.

In some embodiments, a fluid flow path extends along the first flange, the inner sleeve, and the second flange. In some embodiments, the drive member is fluidly sealed from the fluid flow path.

In some embodiments, the inner sleeve includes a first shoulder. In some embodiments, the second flange includes an annular projection and a second shoulder. In some embodiments, the O-ring seal is positioned between the second shoulder and the annular projection. In some embodiments, the alignment bearing is positioned between the first shoulder and the annular projection.

In some embodiments, the drive member further includes an input gear disposed within a gear box. In some embodiments, the gear box is fixedly coupled to the first flange. In some embodiments, an annular gear engages the input gear and is fixedly coupled with the second flange. In some embodiments, the drive member further includes a motor coupled with the input gear and configured to drive the second flange to rotate relative to the first flange.

In some embodiments, the second flange includes a first step at a radially inwards position of the second flange and an annular protrusion extending radially inwards from the second flange. In some embodiments, the annular seal is coupled with the step and the annular protrusion, such that the annular seal is held in position with respect to the second flange. In some embodiments, the first flange includes a second step extending radially outward from the first flange. In some embodiments, the bearing is coupled with the step. In some embodiments, an axial position of the bearing is limited in one axial direction by the second step.

This summary is illustrative only and is not intended to be in any way limiting. Other aspects, inventive features, and advantages of the devices or processes described herein will become apparent in the detailed description set forth herein, taken in conjunction with the accompanying FIGURES, wherein like reference numerals refer to like elements.

### BRIEF DESCRIPTION OF THE FIGURES

The disclosure will become more fully understood from the following detailed description, taken in conjunction with the accompanying FIGURES, wherein like reference numerals to like elements, in which:

FIG. 1 is a perspective view of a mobile fire suppression system, according to some embodiments.

FIG. 2 is another perspective view of the mobile fire suppression system of FIG. 1, according to some embodiments.

FIG. 3 is a perspective view of a fixed fire suppression system, according to some embodiments.

FIG. 4 is another perspective view of the fixed fire suppression system of FIG. 3, according to some embodiments.

FIG. 5 is a perspective view of a conduit assembly of the fixed fire suppression system of FIG. 3, according to some embodiments.

FIG. 6 is a sectional view of a rotatable coupling of the fixed fire suppression system of FIG. 3, according to some embodiments.

FIG. 7 is a sectional view of the rotatable coupling of FIG. 6, according to some embodiments.

FIG. 8 is a sectional view of the rotatable coupling of FIG. 6, according to some embodiments.

FIG. 9 is a block diagram of a control system usable with a fire suppression system, according to some embodiments.

### DETAILED DESCRIPTION

Before turning to the FIGURES, which illustrate certain exemplary embodiments in detail, it should be understood that the present disclosure is not limited to the details or methodology set forth in the description or illustrated in the FIGURES. It should also be understood that the terminology used herein is for the purpose of description only and should not be regarded as limiting.

### Overview

Fire suppressant fluids/agents are commonly discharged in order to suppress fires in different types of areas (e.g., office buildings, homes, schools, industrial facilities, etc.). Larger and more dangerous fire hazards may require a large volume of discharge for adequate suppression.

In certain fire hazard situations, it is advantageous to adjust a discharge direction of a nozzle to target the fire (e.g., direct the nozzle towards the fire or an area of interest such that fire suppressant agent is discharged onto the fire or area of interest). In certain cases it is also advantageous to continually rotate the direction of the discharge in order to suppress fires in multiple or all directions. In order to rotate the direction of discharge, a rotatable coupling is positioned between two fluid conduits to facilitate one conduit rotating with respect to the other. The rotating conduit may be formed into or include an elbow such that the axial rotation of the conduit facilitates the discharge of the fire suppressant fluid/agent in various directions. A rotational actuator (e.g., a drive member, etc.) may facilitate rotation about the rotatable coupling.

For continuous rotation, the rotational actuator may actuate the rotatable coupling with a motor (e.g., an electric motor, a hydraulic motor, a pneumatic motor, etc.). Actuating the rotatable coupling with a motor may facilitate adjusting the direction of discharge and remote control. Remote control of the direction of discharge may be appropriate or desirable when the fire monitoring systems are mounted in inaccessible locations (i.e. extending downward from a ceiling, attached to a wall) or when fire surrounds the fire suppression system. In order to actuate the rotatable coupling such that the flow of a fire suppressant fluid/agent is not disrupted during the rotation, the motor may rotate a gear that engages an annular gear coupled with the conduit to be rotated. Examples of such rotational actuators include a slewing drive or slewing ring.

A rotatable coupling facilitating a fluid flow path may require a swivel sleeve extending from a first conduit to a second conduit. To facilitate rotation of the first conduit with respect to or relative to the second conduit, the swivel sleeve may engage in a reduced frictional manner a bearing member to facilitate consistent rotation. To prevent fluid flow from leaking from the rotational conduit and damaging the rotational actuator, an annular seal (e.g., an O-ring) may engage the swivel sleeve.

Referring generally to the FIGURES, a conduit assembly includes an inlet end with one or more inlet apertures and one or more outlet apertures. A fluid flow path is defined between the inlet apertures and the outlet apertures. A first conduit may be coupled with a second conduit, wherein one or more outlets of the first conduit are coupled with one or more outlets of the second conduit. It should also be understood that the terminology used herein is for the purpose of description only and should not be regarded as limiting.

### System

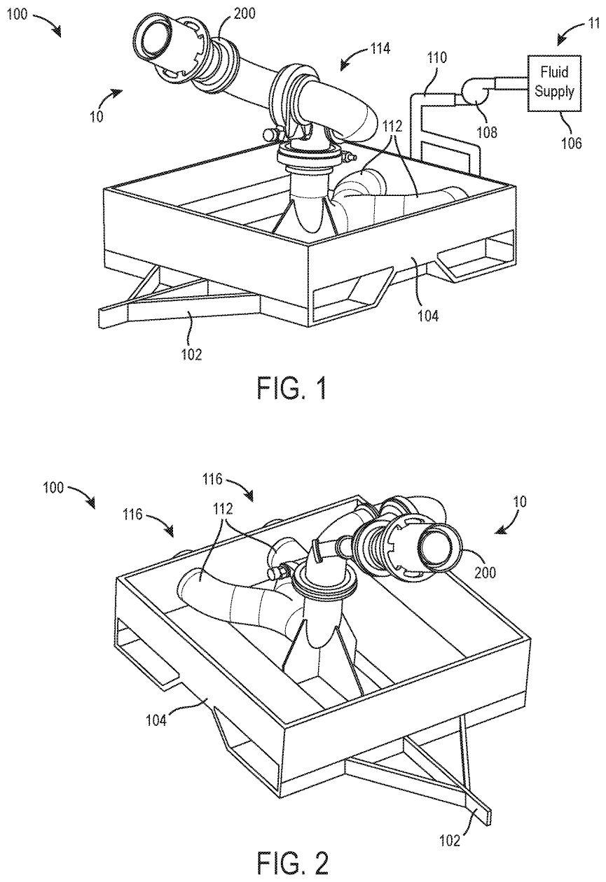

Referring to FIGS. 1-2, a fire suppression system 100 includes a fluid discharge system 10 and a fluid delivery system 11, according to an exemplary embodiment. Fluid discharge system 10 includes nozzle 200. Fluid delivery system 11 is configured to provide fluid discharge system 10 with liquid, fluid, or fire suppressant fluid/agent. The fire suppressant fluid/agent is provided to fluid discharge system 10 by fluid delivery system 11 and sprayed, emitted, ejected, directed, etc., by nozzle 200 for fire suppression purposes. For example, nozzle 200 can be used for pre or post fire activities, de-watering, cooling operations/applications, vapor mitigation, vapor suppression, etc. All such applications of nozzle 200 should be understood to be within the scope of the present disclosure. Additionally, the term “fire suppression” as used herein should be understood to refer to any pre or post fire activities, de-watering activities, cooling operations/applications/activities, vapor mitigation, vapor suppression, etc. Nozzle 200 can be generally referred to as a fire service nozzle, or a nozzle configured to perform various activities related to fire prevention, suppression, mitigation, etc.

Fluid delivery system 11 includes a fluid supply reservoir, a tank, etc., shown as fluid supply 106. In some embodiments, fluid supply 106 is a tank. In other embodiments, fluid supply 106 is a lake, a river, an ocean, etc., or any other supply of water or liquid that can be used by fire suppression system 100 for fire suppression. In some embodiments, fluid supply 106 is a municipal water supply. In other embodiments, fluid supply 106 can be a pressurized water supply with an aperture mounted to a wall, ceiling, floor, or ground (e.g., a fire hydrant). Fluid supply 106 can be any reservoir, container, tank, etc., that is capable of providing sufficient volumes of fluid to fire suppression system 100 for fire suppression purposes. In some embodiments, fluid supply 106 is elevated a distance above fire suppression system 100 (e.g., in a water tower) such that the fluid or liquid provided to fire suppression system has head pressure.

Fluid delivery system 11 can include pump 108, and one or more conduits, hoses, pipes, conduit members, tubular members, etc., shown as tubing 110. Tubing 110 can fluidly couple pump 108 with fluid supply 106 and fire suppression system 10. In some embodiments, tubing 110 can fluidly couple tubes that directly fluidly couple with corresponding conduit members or conduits 112 of fire suppression system 100. Pump 108 pressurizes the fluid such that the fluid is forced to enter conduits 112 of fire suppression system 100 (e.g., at a speed v_{fluid} or at a volumetric flow rate \dot{V}_{fluid}) through inlets 116. For example, the volumetric flow rate of fluid or liquid that is provided to and/or discharged by nozzle 200 can be 1600 gallons per minute. In some embodiments, the flow rate of fluid or fire suppressant fluid/agent that exits or is discharged from nozzle 200 is referred to as the discharge flow rate \dot{V}_{discharge}. In some embodiments, the discharge flow rate \dot{V}_{discharge} is adjustable independently of pressure of fluid/liquid provided to nozzle 200. In some embodiments, the discharge flow rate \dot{V}_{discharge} of the fire suppressant fluid/agent or fluid that exits nozzle 200 is 1600 gallons per minute. In some embodiments, the discharge flow rate discharge of fluid or fire suppressant fluid/agent that exits nozzle 200 is greater than 1600 gallons per minute or less than 1600 gallons per minute.

In some embodiments, the fluid or liquid that nozzle 200 uses for fire suppression (e.g., to discharge onto a fire) is provided to nozzle 200 through conduit system 114. Conduit system 114 can include various joints, bends, (e.g., elbow connectors, T connectors, etc.) that facilitate the transfer of fluid or fire suppressant fluid/agent from fluid delivery system 11 to nozzle 200. Conduit system 114 includes various conduit members, pipes, tubes, tubular members, etc., that include an inner volume for the fire suppressant fluid/agent to travel through. In some embodiments, an inner volume of the various conduit members of conduit system 114 is fluidly coupled with an inner volume of conduits 112 to fluidly couple conduit system 114 and nozzle 200 with fluid supply 106.

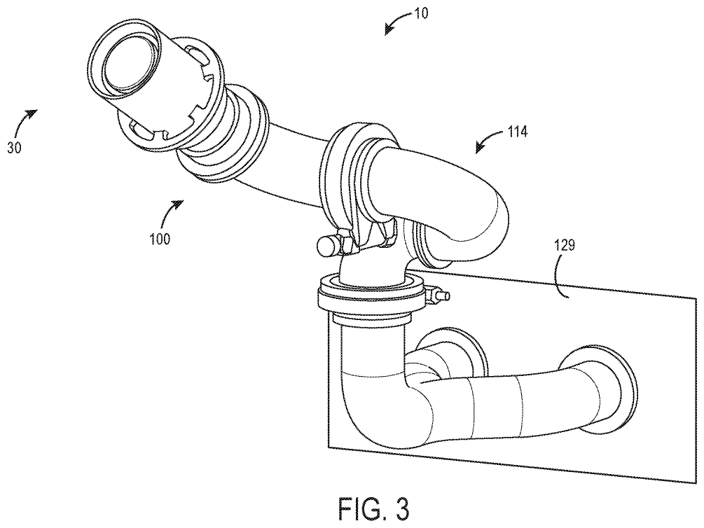

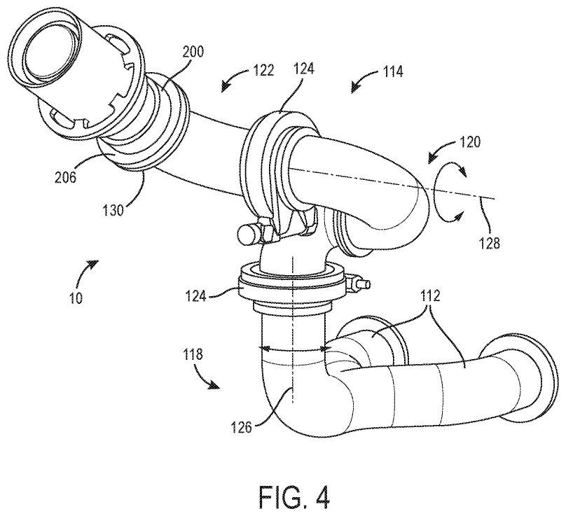

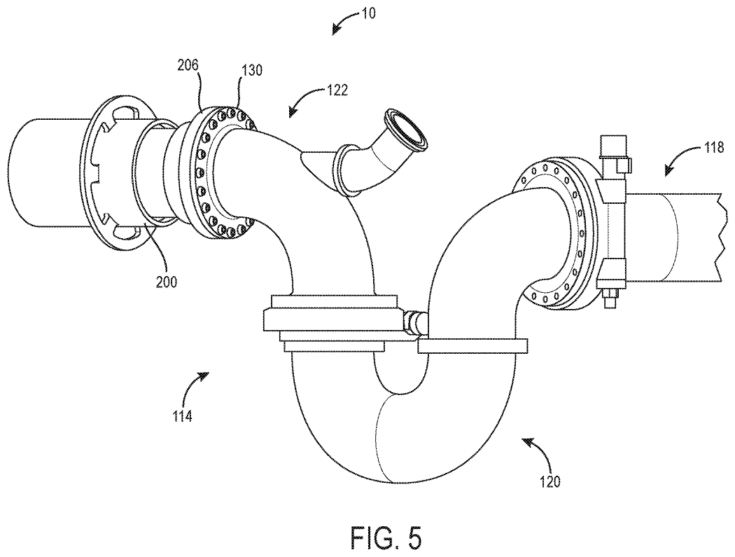

Referring now to FIGS. 3-5, fluid discharge system 10 is shown in greater detail, according to some embodiments. In some embodiments, conduit system 114 includes a base portion of conduits 118 (e.g., a first conduit), a medial portion of conduits 120 (e.g., a second and third conduit), and an upper portion of conduits 122 (e.g., a fourth conduit). In some embodiments, conduits 118 are coupled (e.g., fixedly) with stationary surface 129. In other embodiments, conduits 118 are fixedly coupled with frame 104. Conduits 118 can include conduits 112 that receive the water or fire suppressant fluid/agent from fluid delivery system 11. Conduits 120 (e.g., the medial portion of conduit system 114) is rotatably coupled with conduits 118 through a rotatable coupling 124 (e.g., a first coupling). In some embodiments, rotatable coupling 124 facilitates rotation of conduits 120 and conduits 122 about axis 126 relative to conduits 118. In some embodiments, conduits 120 and conduits 122 are rotatable about axis 126 relative to conduits 118 to facilitate changing the discharge direction of nozzle 200. Axis 126 extends through a center of the rotatable coupling 124 that couples conduits 118 with conduits 120. In some embodiments, axis 126 is a substantially vertical axis such that conduits 120 and conduits 122 are rotatable relative to conduits 118 a full 360 degrees. This facilitates reaching or targeting a fire regardless of the angular position of the conduits relative to fire suppression system 10.

Conduits 122 are rotatably coupled with conduits 120 through another rotatable coupling 124 (e.g., a second coupling) to facilitate rotation of conduits 122 about axis 128 relative to conduits 118 and 120. In some embodiments, rotation of conduits 122 and nozzle 200 about axis 128 facilitates increasing or decreasing a vertical discharge angle of nozzle 200 (e.g., to discharge the water, fluid, fire suppressant fluid/agent, etc., in a higher or lower direction relative to a ground surface to reach fires that are further away). Nozzle 200 is fluidly and fixedly coupled with conduits 122, which are fluidly and rotatably coupled with conduits 120, which are fluidly and rotatably coupled with conduits 118. Rotatable couplings 124 facilitate adjustment of the discharge direction of nozzle 200 in multiple directions (e.g., a horizontal and vertical direction). In some embodiments, conduits 118 are fluidly coupled with conduits 112. In this way, fluid provided to conduits 112 by fluid delivery system 11 is transferred through conduits 118, 120, and 122, to nozzle 200 where it can be discharged onto a fire for fire suppression. In some embodiments, conduits 122 may be forked into multiple outlets, each coupled with a nozzle 200. Each forked outlet may be pointed in a different direction. In this way, fluid that is provided to conduits 122 may be discharged in multiple directions, facilitating a more consistent distribution of fire suppressant fluid/agent.

### Stationary Fire Suppression System

Some embodiments disclosed herein relate to a stationary fire suppression system. For example, referring to FIG. 3, a room, building, enclosure, volume, or area, shown as space 30, is outfitted with a stationary fire suppression system 100, according to an exemplary embodiment. Fire suppression system 100 (e.g., including conduit system 114, nozzle 200, etc.) can be coupled (e.g., mounted) to a wall, floor, ceiling, outdoor surface, etc., shown as surface 129. The fire suppression system 100 is configured to dispense or distribute a fire suppressant fluid/agent onto and/or around a fire within the space 30, thereby controlling or suppressing the fire. The fire suppression system 100 can be used alone or in combination with other types of fire suppression systems (e.g., a building sprinkler system, a portable fire extinguisher, etc.). In some embodiments, multiple fire suppression systems 100 are used in combination with one another to cover a larger area (e.g., each in different rooms of a building, multiple spaces 30, etc.).

### Mobile Fire Suppression System

Some embodiments disclosed herein relate to a mobile fire suppression system. For example, referring again to FIGS. 1-2, fluid discharge system 10 (e.g., conduit system 114, nozzle 200, etc.) can be coupled (e.g., fixedly coupled, mounted, etc.) to a frame, a carriage, a truck, a trailer, a platform, etc., shown as frame 104. In some embodiments, frame 104 is coupled with a vehicle (e.g., a truck, a fire truck, a wheeled vehicle, a vehicle with tractive elements, a vehicle with treads, etc.). In some embodiments, frame 104 is a trailer that can be towed behind a vehicle. Frame 104 can include a connecting portion, an interfacing portion, an attachment member, a tow hitch, etc., shown as attachment member 102. In some embodiments, attachment member 102 is configured to removably couple with a rear end of a vehicle (e.g., at a spindle hitch at the rear of the vehicle). This facilitates transporting fluid discharge system 10 to a site where a fire is located. In some embodiments, fluid discharge system 10 is towed or pulled behind a vehicle, and upon reaching a fire site, is fluidly coupled (e.g., connected) with fluid delivery system 11. In some embodiments, fluid delivery system 11 is also fixedly coupled with frame 104 such that fluid delivery system 11 is towable or transportable to the site where the fire is located. Fluid discharge system 10 can be transported to a fire site or an emergency site and used to suppress a fire at or near the emergency site. It should be understood that the rotatable coupling as described herein may be implemented in either (1) a stationary or a fixed fire suppression system or (2) a mobile fire suppression system.

### Rotatable Coupling

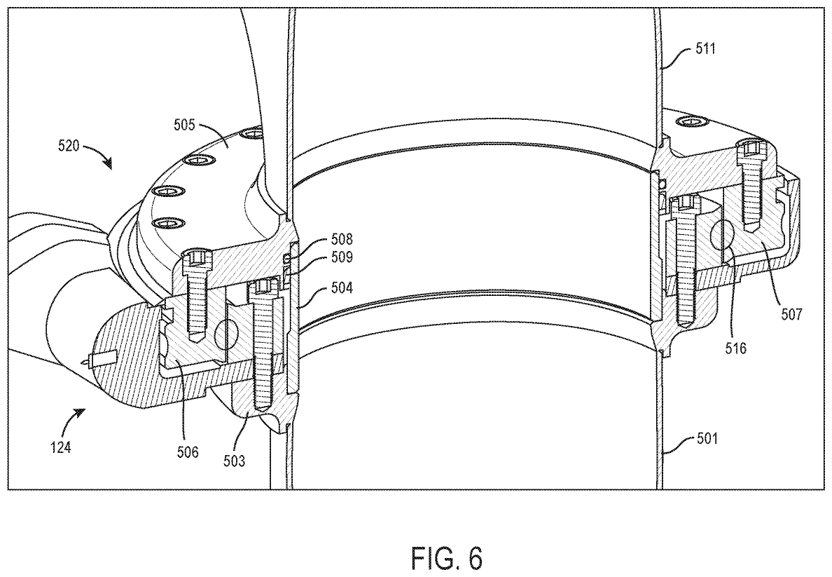

The fire suppression systems disclosed herein may utilize one or more rotatable couplings to facilitate directing a flow of fluid from a nozzle. For example, referring to FIG. 6, rotatable coupling 124 (e.g., a swivel assembly, etc.) is shown in greater detail, according to some embodiments. Rotatable coupling 124 includes first annular member 503 (e.g., a first flange, coupling member, etc.), second annular member 505 (e.g., a second flange, coupling member, etc.), and a rotational actuator 520 disposed between the first annular member 503 and the second annular member 505. First annular member 503 is coupled (e.g., fixedly coupled, mounted, secured, attached, fastened, slip fit, press fit, compression fit, etc.) to a first tubular member, pipe, hose, etc., shown as first conduit 501. Second annular member 505 is coupled (e.g., fixedly coupled, mounted, secured, attached, fastened, slip fit, press fit, compression fit, etc.) to a second tubular member, pipe hose, etc., shown as second conduit 511. Rotatable coupling 124 facilitates rotation or pivoting of second conduit 511 with respect to or relative to first conduit 501.

Swivel sleeve 504 (e.g., an inner swivel sleeve, an inner sleeve, a conduit, a tubular portion, an center tube, etc.) may be disposed between first annular member 503 and second annular member 505 and radially inward from rotational actuator 520. In some embodiments, swivel sleeve 504 is a separate component of rotatable coupling 124, while in other embodiments, swivel sleeve 504 is integrally formed with or otherwise permanently and/or fixedly coupled (e.g., by welding, a press or friction fit, etc.) to one of first annular member 503 and second annular member 505.

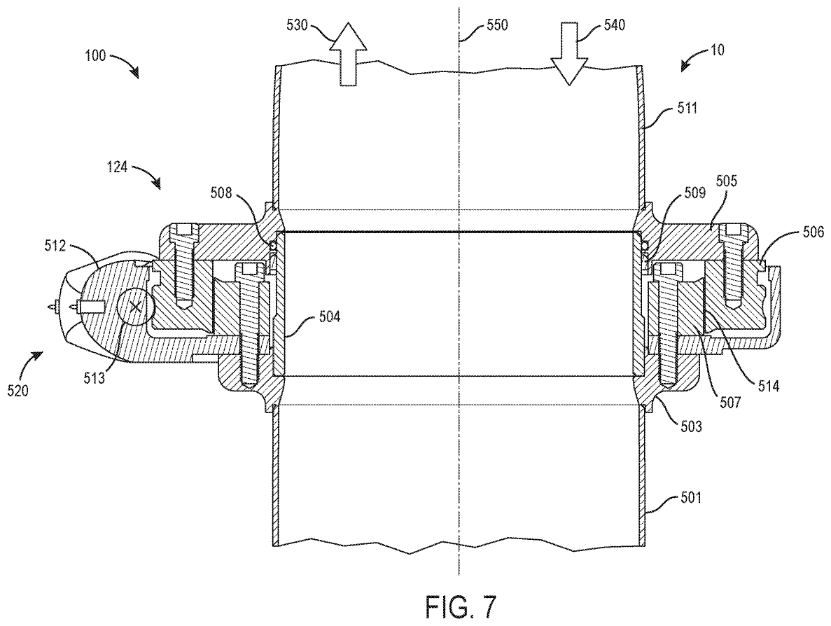

Referring now to FIG. 7, rotational actuator 520 (e.g., a slew ring or drive, etc.) may be coupled with first annular member 503 and second annular member 505 (e.g., ring shaped members, flanges, radially protruding members, etc.) and configured to impart rotational motion between first annular member 503 and second annular member 505. Rotational actuator 520 is disposed longitudinally between first annular member 503 and second annular member 505 and radially outward from swivel sleeve 504. As discussed in further detail elsewhere herein, the positioning of rotational actuator relative to first annular member 503, second member 505, and swivel sleeve 504 prevents fluid flowing between first conduit 501 and second conduit 511 from seeping into or around rotational actuator 520. Rather, a fluidly isolated and sealed flow path is formed by first conduit 501, first annular member 503, swivel sleeve 504, second annular member 505, and second conduit 511.

Rotational actuator 520 may include a gear box 512 (e.g., a housing, etc.) that includes an input gear 513 (e.g., a worm gear, drive gear, main gear, primary gear, wheel gear, etc.) and an annular gear (e.g., a slewing gear, a ring gear, an outer ring, etc.), shown as annular gear 506. Input gear 513 has a set of gear teeth that engage a set of gear teeth on annular gear 506. Input gear 513 is configured to engage and/or drive annular gear 506 to transfer rotational kinetic energy or torque from input gear 513 to annular gear 506 to pivot or rotate first annular member 503 and second annular member 505 relative to each other. Annular gear 506 is fixedly coupled to second annular member 505. Second annular member 505 is fixedly coupled with second conduit 511. Rotation of annular gear 506 drives the second conduit 511 to rotate relative to the first conduit 501. Gear box 512 is fixedly coupled with an inner annular mount 507 (e.g., an inner ring, etc.). Inner annular mount 507 includes holes aligned with holes on gear box 512. In one embodiment, screws or similar fasteners are secured in holes of inner annular mount 507, corresponding holes in gear box 512, and threaded corresponding holes in first annular member 503. In other embodiments other methods of coupling components may be utilized. In further embodiments, inner annular mount 507 is fixedly coupled with the first annular member 503 with an adhesive. Inner annular mount 507 facilitates consistent rotation of annular gear 506. The outer radial face of inner annular mount 507 facilitates reduced frictional interface with inner radial face of annular gear 506. The reduced frictional interface between the outer radial face of inner annular mount 507 and the inner radial face of annular gear 506 is facilitated by a cavity 514 between the outer surface of annular gear 506 and inner annular mount 507 that can be, for example, filled with grease to reduce friction. In other embodiments, an annular bearing (e.g., bushing, ring, sheath, ball bearings, bearing member, etc.) facilitates the frictionless interface between inner annular mount 507 and annular gear 506. For example, a bearing member 516 is disposed between inner annular mount 507 and annular gear 506 to reduce friction between components.

Input gear 513 is rotatably coupled with gear box 512. Input gear 513 engages annular gear 506 such that rotation of input gear 513 drives the rotation of annular gear 506. Annular gear 506 is fixedly coupled with second annular member 505. Second annular member 505 is fixedly coupled with second conduit 511. Accordingly, rotating input gear 513 drives the rotation of second conduit 511 relative to first conduit 501.

In one embodiment, input gear 513 may be driven by a motor. In some embodiments, the motor is remotely controlled. In other embodiments, input gear 513 may be driven by a manual actuation device, such as a wheel, handle, lever, standard slew, etc.

In some embodiments, a fluid flow path may extend along the longitudinal axis 550. Fluid flow path 530 (upwards) or fluid flow path 540 (downwards) extends through the inner volumes of conduits 511 and 501 and passes through the inner volume of rotatable coupling 124. Swivel sleeve 504 may extend between first annular member 503 and second annular member 505, thereby facilitating fluid flow across rotatable coupling 124 and shielding rotational actuator 520 from fire suppressant fluid/agent leakage. Swivel sleeve 504 facilitates fluid flow path 530 or fluid flow path 540 through the inner volume of rotatable coupling 124 by extending through rotational actuator 520 and into second annular member 505.

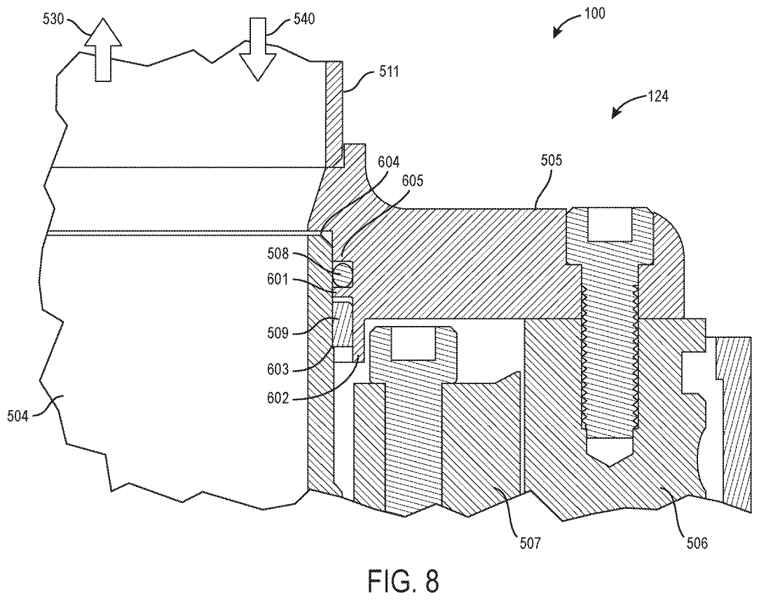

Referring now to FIG. 8, rotatable coupling 124 further includes annular seal 508 (e.g., a dynamic O-ring seal) and annular bearing 509 (e.g., an alignment ring or member, etc.), according to some embodiments. Swivel sleeve 504 extends longitudinally upward into second annular member 505. To avoid friction between swivel sleeve 504 and second annular member 505 during rotation, a cavity 604 is defined between swivel sleeve 504 and second annular member 505. Fire suppressant fluid/agent is prevented from flowing through cavity 604 into cavity 514, cavity 515, and/or out of fire suppression system 100 by annular seal 508. Annular seal 508 is positioned radially outward from swivel sleeve 504 and radially inward from second annular member 505. Annular seal 508 is positioned within a depression (e.g., channel, groove, recess, etc.) of second annular member 505 and seals against swivel sleeve 504. The longitudinally upwards end of annular seal 508 is secured by a step 605 (e.g., a first step, shoulder, etc.) on second annular member 505. The longitudinally downwards end of annular seal 508 is secured by an annular protrusion 601 (e.g., a second step, shoulder, etc.) extending radially inward from the second annular member 505. Annular seal 508 is secured in the radially inward direction by slidably interfacing with swivel sleeve 504. Annular seal 508 is secured in the radially outward direction by slidably interfacing with second annular member 505. In some embodiments, annular seal 508 is circumferentially slidable with respect to second annular member 505. In other embodiments, annular seal 508 is fixedly coupled with second annular member 505.

To facilitate consistent rotation of second annular member 505 with respect to first annular member 503, annular bearing 509 is positioned to interface with swivel sleeve 504 and second annular member 505. Annular bearing 509 is positioned radially outward from first annular member 503 and radially inward from second annular member 505. Annular bearing 509 is slidably coupled with swivel sleeve 504. Annular bearing 509 interfaces with an annular protrusion 602 that forms part of second annular member 505 and extends downward. In some embodiments, annular bearing 509 is fixedly coupled to annular protrusion 602. In other embodiments, annular bearing 509 slidably interfaces with annular protrusion 602. A longitudinally downward facing surface of annular bearing 509 is supported by a step 603 on swivel sleeve 504. Step 603 protrudes radially outward from swivel sleeve 504. In some embodiments, the longitudinally upward facing surface of annular bearing 509 is secured by interfacing with an annular protrusion 601 that forms part of second annular member 505 and extends radially inward. In some embodiments, annular seal 508 is positioned longitudinally upwards from annular bearing 509. In other embodiments, annular seal 508 is positioned longitudinally downwards from annular bearing 509. In other words, annular seal 508 may be positioned either upstream or downstream from annular bearing 509 based on the particular construction of rotatable coupling 124.

Annular bearing 509 is coupled with second annular member 505. Swivel sleeve 504 is slidably coupled with annular bearing 509. Swivel sleeve 504 is fixedly coupled with first annular member 503. Accordingly, annular bearing 509 facilitates the consistent rotation of first annular member 503 with respect to second annular member 505 and maintains proper alignment of swivel sleeve 504 relative to first annular member 503 and second annular member 505.

In some embodiments, the rotatable coupling may be assembled by using the conduit 501 as a base. For example, referring again to FIG. 6, first annular member 503 may then be welded to first conduit 501. Swivel sleeve 504 may then be welded to first annular member 503. Bearing 509 may then be placed around swivel sleeve 504 and on top of step 603, as shown in FIG. 8. Rotational actuator 520 may then be placed on top of first annular member 503. Rotational actuator 520 may then be secured to first annular member 503 by inserting screws through holes in inner annular mount 507 and gear box 512 and securing the screws in matching threaded holes in first annular member 503. Seal 508 may then be secured to second annular member 505 by placing the seal in the depression formed by step 605 and protrusion 601 on second annular member 505, as shown in FIG. 8. Second annular member 505 may then be placed on top of rotational actuator 520. Second annular member 505 may then be secured to rotational actuator 520 by inserting screws through holes in second annular member 505 and securing the screws in matching threaded holes in annular gear 506. Second conduit 511 may then be welded to second annular member 505. In other embodiments, the rotatable coupling may be assembled using these steps in a different order or using more or fewer steps.

### Control System

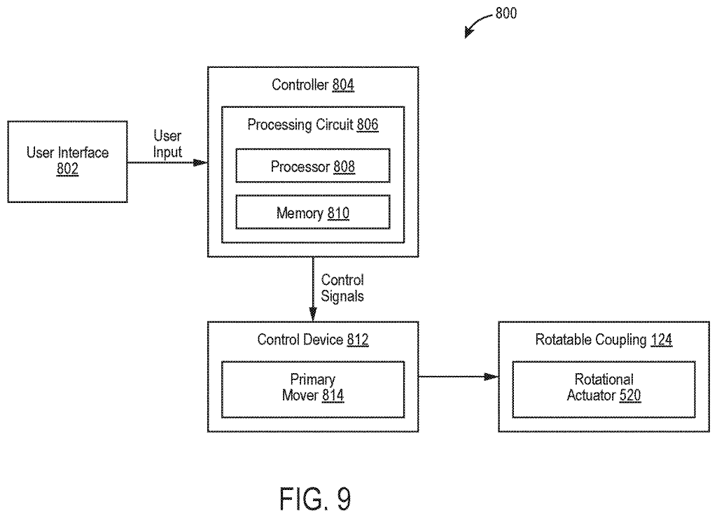

Referring now to FIG. 9, a control system 800 (e.g., a portion of a fire suppression system) for actuating the rotatable coupling 124 is shown, according to some embodiments. Control system 800 includes a human machine interface or a user interface 802, a controller 804, and control device 812, and is operatively coupled to rotatable coupling 124, according to some embodiments.

User interface 802 can be any human machine interface, input device, personal computer device, etc., that can receive a user input. In some embodiments, user interface 802 includes any of or a combination of a touch screen, one or more buttons, one or more levers, one or more switches, dials, etc. that are configured to receive a user input from an operator of nozzle 200. User interface 802 is communicably connected with controller 804 and is configured to provide the user input to controller 804, according to one embodiment. In other embodiments, user interface 802 is directly communicably connected with control device 812 and is configured to provide the user input directly to control device 812. For example, user interface 802 can be a human machine interface of any of control devices 812. In other embodiments, user interface 802 is a smartphone that wirelessly communicates with controller 804 and/or control device 812. In some embodiments, user interface 802 is wiredly communicably connected with controller 804 and/or control device 812. In some embodiments, user interface 802 and controller 804 each include a wireless transceiver and are configured to communicate wirelessly using a variety of wireless communications protocols (e.g., LoRa, Bluetooth, Zigbee, Wi-Fi, near field communications (NFC), etc.).

Controller 804 can include a communications interface. The communications interface may facilitate communications between controller 804 and external systems, devices, sensors, etc. (e.g., user interface 802, control devices 812, etc.) for allowing user control, monitoring, and adjustment to any of the communicably connected devices, sensors, systems, primary movers, etc. The communications interface may also facilitate communications between controller 804 and a human machine interface. The communications interface may facilitate communications between controller 804 and user interface 802, control device 812, etc.

The communications interface can be or include wired or wireless communications interfaces (e.g., jacks, antennas, transmitters, receivers, transceivers, wire terminals, etc.) for conducting data communications with sensors, devices, systems, etc., of control system 800 or other external systems or devices. In various embodiments, communications via the communications interface can be direct (e.g., local wired or wireless communications) or via a communications network (e.g., a WAN, the Internet, a cellular network, etc.). For example, the communications interface can include an Ethernet card and port for sending and receiving data via an Ethernet-based communications link or network. In another example, the communications interface can include a Wi-Fi transceiver for communicating via a wireless communications network. In some embodiments, the communications interface is or includes a power line communications interface. In other embodiments, the communications interface is or includes an Ethernet interface, a USB interface, a serial communications interface, a parallel communications interface, etc.

Controller 804 includes a processing circuit 806, processor 808, and memory 810, according to some embodiments. Processing circuit 806 can be communicably connected to the communications interface such that processing circuit 806 and the various components thereof can send and receive data via the communications interface. Processor 808 can be implemented as a general purpose processor, an application specific integrated circuit (ASIC), one or more field programmable gate arrays (FPGAs), a group of processing components, or other suitable electronic processing components.

Memory 810 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 810 can be or include volatile memory or non-volatile memory. Memory 810 can include database components, object code components, script components, or any other type of information structure for supporting the various activities and information structures described in the present application. According to some embodiments, memory 810 is communicably connected to processor 808 via processing circuit 806 and includes computer code for executing (e.g., by processing circuit 806 and/or processor 808) one or more processes described herein.

Controller 804 is configured to receive the user input from user interface 802 and output control signals to control device 812 to actuate rotatable coupling 124. In some embodiments, controller 804 generates the control signals and provides the control signals to control device 812 to activate rotational actuator 520.

Control device 812 can be or include any device or primary mover configured to actuate rotatable coupling 124. In some embodiments, control device 812 is or includes a primary mover 814 (e.g., an electric actuator, a rotary actuator, an engine, etc.) or rotational actuator 520. In some embodiments, control device 812 directly operates rotational actuator 520 to actuate rotatable coupling 124.

In use, a user provides an input via user interface 802. For example, the input may define a desired mode of operation or a desired position for nozzle 200 (e.g., an oscillating pattern, a new trajectory, etc.). Controller 804 receives the input and provides an appropriate control signal to control device 812. Based on the control signal, control device 812 and primary mover 814 drive rotational actuator 520 of rotatable coupling 124 to move nozzle 200 according to the user input.

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the FIGURES and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the fire suppression system as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. Other substitutions, modifications, changes, and omissions may be made in the design, operating conditions and arrangement of the exemplary embodiments without departing from the scope of the present disclosure.

What is claimed is:

1. A rotating conduit assembly for a fire suppression system, the conduit assembly comprising:
a first conduit configured to fluidly coupled with a fluid source;
a second conduit; and
a rotatable coupling configured to rotatably couple the first conduit with the second conduit, the rotatable coupling comprising:
a first annular member fixedly coupled with the first conduit;
a second annular member fixedly coupled with the second conduit;
an inner sleeve extending between the first annular member and the second annular member;
an annular seal disposed between the inner sleeve and the second annular member and configured to provide a fluidic seal between the inner sleeve and the second annular member; and
a rotational actuator disposed radially outward from the inner sleeve and configured to rotate the first annular member relative to the second annular member.

2. The rotating conduit assembly of claim 1, further comprising:
an annular bearing disposed between the inner sleeve and the second annular member.

3. The rotating conduit assembly of claim 1, wherein the rotational actuator comprises:
an input gear disposed within a gear box, the gear box fixedly coupled to the first annular member;
an annular gear engaging the input gear and fixedly coupled with the second annular member; and
a motor coupled with the input gear for rotating the second annular member with respect to the first annular member.

4. The rotating conduit assembly of claim 1, wherein:
at least one of the first conduit and second conduit form an elbow.

5. The rotating conduit assembly of claim 1, wherein the second annular member comprises:
a step at a radially inwards position of the second annular member;
an annular protrusion extending radially inwards from the second annular member; and
wherein the annular seal is positioned between the step and the annular protrusion.

6. The rotating conduit assembly of claim 1, wherein:
a step extends radially outward from the first annular member; and
the bearing is coupled with the step, wherein an axial position of the bearing is limited in one axial direction by the step.

7. The rotating conduit assembly of claim 1, further comprising:
a third conduit fluidly coupled with the second conduit;
a fourth conduit; and
a second rotatable coupling fluidly coupled with the third conduit and the fourth conduit.

8. The rotating conduit assembly of claim 7, wherein:
at least one of the first conduit, second conduit, third conduit, or the fourth conduit form an elbow and wherein the fourth conduit is fluidly coupled with a nozzle.

9. A mobile fire suppression system, the mobile fire suppression system comprising:
a mobile mount;
a first conduit coupled with the mobile mount and configured to fluidly couple with a fluid source;
a second conduit; and
a rotatable coupling providing a sealed fluid flow path between the first conduit and the second conduit for providing relative rotation between the first conduit and the second conduit, the rotatable coupling comprising:
a first annular member fixedly coupled with the first conduit;
a second annular member fixedly coupled with the second conduit;
an inner sleeve extending between the first annular member and the second annular member;
an annular seal disposed between the inner sleeve and the second annular member and configured to provide a fluidic seal between the inner sleeve and the second annular member; and
a rotational actuator disposed radially outward from the inner sleeve and configured to rotate the first annular member relative to the second annular member.

10. The mobile fire suppression system of claim 9, further comprising:
an annular bearing disposed between the inner sleeve and the second annular member.

11. The mobile fire suppression system of claim 9, wherein the rotational actuator comprises:
an input gear disposed within a gear box, the gear box fixedly coupled with the first annular member;
an annular gear engaging the input gear and fixedly coupled with the second annular member; and
a motor coupled with the input gear for rotating the second annular member with respect to the first annular member.

12. The mobile fire suppression system of claim 9, wherein the second annular member comprises:
a step at a radially inwards position of the second annular member;
an annular protrusion extending radially inwards from the second annular member; and
wherein the annular seal is positioned between the step and the annular protrusion.

13. The mobile fire suppression system of claim 9, wherein:
a step extends radially outward from the first annular member; and
the bearing is coupled with the step, wherein an axial position of the bearing is limited in one axial direction by the step.

14. The mobile fire suppression system of claim 9, further comprising:
a third conduit fluidly coupled with the second conduit;
a fourth conduit; and
a second rotatable coupling fluidly coupled with the third conduit and the fourth conduit.

15. The mobile fire suppression system of claim 14, wherein:
at least one of the first conduit, second conduit, third conduit, and fourth conduit form an elbow and wherein the fourth conduit is fluidly coupled with a nozzle.

16. A rotatable coupling comprising:
a first flange configured to fluidly couple with a first conduit;
a second flange configured to fluidly couple with a second conduit;
an inner sleeve positioned between the first flange and the second flange, the inner sleeve fixedly coupled to the first flange and rotatably coupled to the second flange;
a seal disposed between the inner sleeve and the second flange;
an alignment bearing disposed between the inner sleeve and the second flange; and
a drive member positioned radially outward from the inner sleeve and longitudinally between the first flange and the second flange and configured to rotate the second flange relative to the first flange.

17. The rotatable coupling of claim 16, wherein:
a fluid flow path extends along the first flange, the inner sleeve, and the second flange;
and
wherein the drive member is fluidly sealed from the fluid flow path.

18. The rotatable coupling of claim 16, wherein:
the inner sleeve includes a first shoulder;
the second flange includes an annular projection and a second shoulder;
the O-ring seal is positioned between the second shoulder and the annular projection; and
the alignment bearing is positioned between the first shoulder and the annular projection.

19. The rotatable coupling of claim 16, wherein the drive member further comprises:
an input gear disposed within a gear box, the gear box fixedly coupled to the first flange;
an annular gear engaging the input gear and fixedly coupled with the second flange; and
a motor coupled with the input gear and configured to drive the second flange to rotate relative to the first flange.

20. The rotatable coupling of claim 16, wherein
the second flange comprises:
a first step at a radially inwards position of the second flange; and
an annular protrusion extending radially inwards from the second flange;
wherein the annular seal is coupled with the step and the annular protrusion, such that the annular seal is held in position with respect to the second flange; and
the first flange comprises:
a second step extending radially outward from the first flange; and
wherein the bearing is coupled with the step, wherein an axial position of the bearing is limited in one axial direction by the second step.
